(19) United States
(12) Patent Application Publication
(10) Pub. No.: US 2019/0003664 A1
(43) Pub. Date: Jan. 3, 2019

(54) FLEXIBLE LED PROJECTION LIGHT

(71) Applicant: HESHAN TONGFANG LIGHTING TECHNOLOGY COMPANY LIMITED, Guangdong (CN)

(72) Inventor: Baosheng FAN, Guangdong (CN)

(21) Appl. No.: 16/067,582

(22) PCT Filed: Aug. 1, 2017
(86) PCT No.: PCT/CN2017/095441

§ 371 Date: Jun. 29, 2018

(30) Foreign Application Priority Data
Aug. 3, 2016 (CN) 201620839578.0

(51) Int. Cl. F21S 4/22; F21V 31/00

(52) U.S. Cl. CPC F21S 4/22; F21Y 2115/10; F21V 31/00

(57) ABSTRACT

Provided is a flexible LED projection lamp, comprising: a plurality of LED lamp boards (1), wherein the LED lamp board (1) is a circuit board (3) having an LED (2) soldered thereon, each of the LED lamp boards (1) is connected by means of a flexible wire (4), and a lens (6) is arranged above the LED lamp board (1) at a position corresponding to the LED (2); and an injection-type insulating sheath (7), wherein the injection-type insulating sheath (7) comprises a plurality of external injection-type units (8) and a flexible connector (9) that connects two adjacent external injection-type units (8), the external injection-type unit (8) covers the LED lamp board (1) and a part of the lens (6) below a top of the lens, and the flexible connector (9) covers the flexible wire (4) between two adjacent LED lamp boards (1). The flexible LED projection lamp has optimal bending performance at the position of each flexible connector (9), and is suitable for mounting on various curved objects and is easy to install, has a wide range of application and optimal waterproof performance.

### TECHNICAL FIELD

The present invention relates to the field of decoration or lighting, and more particularly, to a flexible LED projection lamp that is easy to install, and has a wide range of application and optimal waterproof performance.

### BACKGROUND

LED lamps have many advantages such as energy saving, environmentally friendly, long service life, and high luminous efficiency, and they are rapidly replacing traditional lamps.

A Linear LED projection lamp is one of the common LED lamps and widely used in lighting decoration for indoor and outdoor walls of various buildings An existing kind of linear LED projection lamp is know from the patent document CN204062961U. Such linear LED projection lamp has a rigid lamp body, which is inconvenient to install in some situations, for example, a position where the linear LED projection lamp is required to be folded or bent. In addition, such linear LED projection lamp has a complicated waterproof configuration, and a high cost.

Therefore, it is necessary to make a further improvement to the above linear LED projection lamp.

### SUMMARY

An objective of the present invention is to provide a flexible LED projection lamp which is easy to install and has a wide range of application and optimal waterproof performance.

To achieve the above objective, a flexible LED projection lamp is provided, including:

a plurality of LED lamp boards, wherein each LED lamp board comprises a circuit board and an LED soldered on the circuit board, the plurality of LED lamp boards are connected to one another via a flexible wire, and each LED lamp board is provided with a lens at a position corresponding to the LED; and

an injection-type insulating sheath, comprising a plurality of external injection-type units, wherein every two adjacent external injection-type units are connected to each other via a flexible connector, each external injection-type unit is adapted to cover one of the plurality of LED lamp boards and a part of a corresponding lens below a top of the corresponding lens, and the flexible connector is adapted to cover the flexible wire between two adjacent LED lamp boards.

Further, the flexible LED projection lamp also includes an internal injection-type unit adapted to cover one of the plurality of LED lamp boards and a part of a corresponding lens below a top of the corresponding lens, and the external injection-type unit is adapted to cover the internal injection-type unit and expose the top of the corresponding lens.

Further, the external injection-type unit has a cross section in a shape of a square, the flexible connector also has a cross section in a shape of a square, the cross section of the flexible connector has a length less than that of the cross section of the external injection-type unit, and the cross section of the flexible connector has a width less than that of the cross section of the external injection-type unit.

Further, each LED lamp board is provided with a lens holder at a position corresponding to the LED lamp, and the lens is fixed on the lens holder.

The present invention achieves the following beneficial effects. According to the present invention, the internal light source is configured in such a way that two adjacent LED lamp boards are connected to each other via a flexible wire, and an insulating sheath is injection-molded on the external of the internal light source. The insulating sheath includes a plurality of injection-type units covering the periphery of each LED lamp board respectively and a flexible connector covering the periphery of the flexible wire, so that the flexible LED projection lamp has optimal bending performance at the position of each flexible connector, and is suitable for mounting on various curved objects, with a wide range of application and easy installation. Both of the LED lamp board and the flexible wire can be sealed by the insulating sheath and the lens integrally connected to the insulating sheath, so that an optimal waterproof performance can be achieved.

It should be noted that any product implementing the present invention is not required to achieve all the above effects at the same time.

### BRIEF DESCRIPTION OF DRAWINGS

The present invention may be best understood by reference to the following description of embodiments taken in conjunction with the accompanying drawings.

FIG. 1 is a perspective diagram illustrating an embodiment of the present invention.

FIG. 2 is an exploded diagram illustrating an embodiment of the present invention.

### DETAILED DESCRIPTION

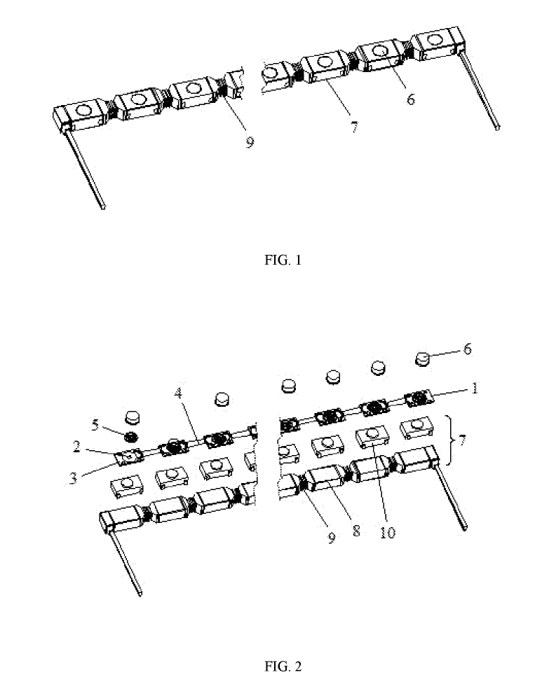

Referring to a preferred embodiment of the present invention as shown in FIG. 1 and FIG. 2, a flexible LED projection lamp is provided, including:

a plurality of LED lamp boards 1, wherein each LED board 1 includes a circuit board 3 and a single SMD (Surface Mounted Device) LED lamp 2 soldered on the circuit board, the plurality of LED lamp boards 1 are connected to one another via a flexible wire 4, each LED lamp board 1 is provided with a lens holder 5 at a position corresponding to the LED 2, and a lens is arranged on the lens holder fixedly;

an injection-type insulating sheath 7, including a plurality of external injection-type units 8, wherein every two adjacent external injection-type units 8 are connected to each other via a flexible connector 9, each external injection-type unit 8 is adapted to cover one of the plurality of LED lamp boards 1 and a part of a corresponding lens 6 below a top of the corresponding lens 6, and the flexible connector 9 is adapted to cover the flexible wire 4 between two adjacent LED lamp boards 1.

The Flexible LED projection lamp also includes an internal injection-type unit 10 adapted to cover one of the plurality of LED lamp boards 1 and a part of a corresponding lens 6 below a top of the corresponding lens 6, and the external injection-type unit 8 is adapted to cover the internal injection-type unit 10 and expose the top of the corresponding lens 6.

The external injection-type unit 8 has a cross section in a shape of a square, the flexible connector 9 also has a cross section in a shape of a square, the cross section of the flexible connector 9 has a length less than that of the cross section of the external injection-type unit 8, and the cross section of the flexible connector 9 has a width less than that of the cross section of the external injection-type unit 8.

The present invention can achieve the following beneficial effects. According to the present invention, the internal light source is configured in such a way that two adjacent LED lamp boards 1 are connected to each other via a flexible wire 4, and an insulating sheath 7 is injection-molded on the external of the internal light source. The insulating sheath 7 includes a plurality of injection-type units 8, 10 covering the periphery of each LED lamp board respectively and a flexible connector 9 covering the periphery of the flexible wire 4, so that the flexible LED projection lamp has optimal bending performance at the position of each flexible connector 9, and is suitable for mounting on various curved objects, with a wide range of application and easy installation Both of the LED lamp board 1 and the flexible wire 4 are sealed by the insulating sheath 7 and the lens 6 integrally connected to the insulating sheath 7, so that an optimal waterproof performance can be achieved.

Preferred embodiments of the present invention have been described above, but it should be understood that the present invention is not limited to the above embodiments, and alternative embodiments will become apparent to those skilled in the art to which the present disclosure pertains without departing from its scope, as long as these alternative embodiments achieve the technical effects of the present invention.

1. A flexible LED projection lamp, comprising:
a plurality of LED lamp boards, wherein each LED lamp board comprises a circuit board and an LED soldered on the circuit board, the plurality of LED lamp boards are connected to one another via a flexible wire, and each LED lamp board is provided with a lens at a position corresponding to the LED; and
an injection-type insulating sheath, comprising a plurality of external injection-type units, wherein every two adjacent external injection-type units are connected to each other via a flexible connector, each external injection-type unit is adapted to cover one of the plurality of LED lamp boards and a part of a corresponding lens below a top of the corresponding lens, and the flexible connector is adapted to cover the flexible wire between two adjacent LED lamp boards.

2. The flexible LED projection lamp of the claim 1, further comprising an internal injection-type unit adapted to cover one of the plurality of LED lamp boards and a part of a corresponding lens below a top of the corresponding lens, and the external injection-type unit is adapted to cover the internal injection-type unit and expose the top of the corresponding lens.

3. The flexible LED projection lamp of claim 1, wherein the external injection-type unit has a cross section in a shape of a square, the flexible connector also has a cross section in a shape of a square, the cross section of the flexible connector has a length less than that of the cross section of the external injection-type unit, and the cross section of the flexible connector has a width less than that of the cross section of the external injection-type unit.

4. The flexible LED projection lamp of claim 1, wherein each LED lamp board is provided with a lens holder at a position corresponding to the LED, and the lens is fixed on the lens holder.
